(19) United States
(12) Patent Application Publication
(10) Pub. No.: US 2013/0342663 A1
(43) Pub. Date: Dec. 26, 2013

(54) EYEWEAR DEVICE, DISPLAY DEVICE, VIDEO SYSTEM COMPRISING EYEWEAR DEVICE AND DISPLAY DEVICE, AND VIDEO SYSTEM CONTROL METHOD

(71) Applicant: PANASONIC CORPORATION, Osaka (JP)

(72) Inventors: Yoshihiro HARA, Osaka (JP); Hiroki URABE, Osaka (JP)

(21) Appl. No.: 13/908,564

(22) Filed: Jun. 3, 2013

Related U.S. Application Data
(63) Continuation of application No. PCT/JP2012/001827, filed on Mar. 15, 2012.
(60) Provisional application No. 61/453,717, filed on Mar. 17, 2011.

(51) Int. Cl. H04N 13/04; G02B 27/22

(52) U.S. Cl. CPC H04N 13/0429; G02B 27/2264
USPC 348/54; 359/464

(57) ABSTRACT

The instant application discloses an eyewear device including: a light amount adjuster which adjusts a light amount transmitted to left and right eyes of an observer to perform assistance operation that assists in observing a video so that the video is stereoscopically perceived; a battery portion which stores power for the light amount adjuster to perform the assistance operation; and a transmitter configured to transmit a notification signal for notifying a condition of the battery portion. The notification signal contains charge information, which indicates whether or not the battery portion is being charged, and remaining level information, which indicates a power amount stored in the battery portion.

### TECHNICAL FIELD

The present application relates to video technologies which allow an observer to appropriately observe a stereoscopic video.

### BACKGROUND ART

Video systems to allow observation of a stereoscopic video are widely used. A video system typically includes a display device, which alternately displays a left frame image observed by the left eye and a right frame image observed by the right eye, and an eyewear device, which performs an assistance operation to make the left frame image observed by the left eye and the right frame image observed by the right eye (c.f., Patent Documents 1 to 3). Due to the assistance operation, an observer observes the left frame image just by the left eye and the right frame image just by the right eye. Since positional differences or alike are provided between an object rendered in the left frame image and an object rendered in the right frame image, the observer may stereoscopically perceive a video displayed by the display device.

The assistance operation of an eyewear device typically depends on power. Therefore, a battery portion such as battery cells is built into the eyewear device. The eyewear device is capable of performing an appropriate assistance operation while the battery portion stores sufficient power. On the other hand, if power in the battery portion is insufficient, the assistance operation of the eyewear device may not appropriately synchronize with a switching operation between left and right frame images on the display device.

Patent Document 1 described above discloses techniques for notifying a power amount stored in an eyewear device to an observer. According to the disclosure of Patent Document 1, a display device displays an information image which represents a power amount stored in the eyewear device. The observer continues observing a video or replaces a battery of the eyewear device in response to the information image displayed on the display device.

The information image displayed by the display device is useful for the observer unless a storage amount of electricity in the eyewear device changes so much. However, if the storage amount of electricity significantly changes within a short period of time, the information image displayed by the display device is likely to become useless for the observer. In addition, the information image may interfere with observation of a video if the information image overlaps with an image of contents (e.g., a movie) displayed by the display device.
Patent Document 1: US Patent Application Publication No. 2011/0248859
Patent Document 2: US Patent Application Publication No. 2011/0242290
Patent Document 3: US Patent Application Publication No. 2011/0228056

### SUMMARY

An object of the present invention is to provide video technologies which appropriately notify a condition of an eyewear device to an observer.

An eyewear device according to one aspect of the present invention includes: a light amount adjuster which adjusts a light amount transmitted to left and right eyes of an observer to perform an assistance operation that assists in observing a video so that the video is stereoscopically perceived; a battery portion which stores power for the light amount adjuster to perform the assistance operation; and a transmitter configured to transmit a notification signal for notifying a condition of the battery portion. The notification signal contains charge information, which indicates whether or not the battery portion is being charged, and remaining level information, which indicates a power amount stored in the battery portion.

A display device according to another aspect of the present invention includes: a receiver configured to receive a notification signal for notifying a condition of an eyewear device which performs an assistance operation to assist in observing a video so that the video is stereoscopically perceived; an image generator configured to generate a condition image which represents the condition of the eyewear device in response to the notification signal received by the receiver; and a display portion configured to display the condition image. The notification signal contains charge information, which indicates whether or not the eyewear device is being charged, and remaining level information, which indicates a power amount stored in the eyewear device. The image generator generates a power amount image, which represents the power amount stored in the eyewear device, as the condition image if the charge information indicates that the eyewear device is not being charged.

A video system according to yet another aspect of the present invention includes: a display device configured to display a video which is stereoscopically perceived by an observer; and an eyewear device configured to perform an assistance operation which assists in observing the video so that the video is stereoscopically perceived. The eyewear device includes: a light amount adjuster which adjusts a light amount transmitted to left and right eyes of the observer to perform the assistance operation; a battery portion which stores power for the light amount adjuster to perform the assistance operation; and a transmitter configured to transmit a notification signal for notifying a condition of the battery portion. The notification signal contains charge information, which indicates whether or not the battery portion is being charged, and remaining level information, which indicates a power amount stored in the battery portion. The display device includes: a receiver configured to receive the notification signal; an image generator configured to generate a condition image, which represents the condition of the battery portion, in response to the notification signal received by the receiver; and a display portion configured to display the condition image. The image generator generates a power amount image, which represents a power amount stored in the battery portion, as the condition image if the charge information indicates that the battery portion is not being charged.

A video system control method according to yet another aspect of the present invention includes steps of communicating a notification signal between a display device, which displays a stereoscopic video, and an eyewear device, which performs an assistance operation that assists in observing the video, in order to notify a condition of the eyewear device; and causing the display device to generate and display a condition image which represents the condition of the eyewear device in response to the notification signal. The notification signal contains charge information, which indicates whether or not the eyewear device is being charged, and remaining level information, which indicates a power amount stored in the eyewear device. The display device generates and displays a power amount image which represents a power amount stored in the eyewear device as the condition image if the charge information indicates that the eyewear device is not being charged.

The present invention may appropriately notify a condition of an eyewear device to an observer.

The object, features and advantages of the present invention will become more apparent based on the ensuing detailed description and appended drawings.

### BRIEF DESCRIPTION OF THE DRAWINGS

FIG. 1 is a schematic perspective view of an exemplary eyewear device.

FIG. 2 is a schematic block diagram showing a functional configuration of the eyewear device depicted in FIG. 1.

FIG. 3 is a schematic view of an exemplary display device.

FIG. 4 is a schematic block diagram showing a functional configuration of the display device depicted in FIG. 3.

FIG. 5A is a schematic view of an exemplary video system.

FIG. 5B is a schematic view of the video system shown in FIG. 5A.

FIG. 5C is a schematic view of the video system shown in FIG. 5B.

FIG. 6 is a schematic timing chart showing an operation of a light amount adjuster of the eyewear device shown in FIG. 2.

FIG. 7 is a timing chart schematically showing communication between the eyewear device and the display device.

FIG. 8 is a schematic view of a structure of a packet-structured payload section used as a notification signal.

FIG. 9 is a schematic view of a data structure in a data block allocated to information E.

FIG. 10 is an exemplary table showing an expression pattern of charge information.

FIG. 11A is an exemplary table showing an expression pattern of first remaining level information.

FIG. 11B is an exemplary table showing an expression pattern of second remaining level information.

FIG. 12 is a schematic flow chart of a method for controlling the video system depicted in FIGS. 5A to 5C.

### DETAILED DESCRIPTION

Exemplary video technologies are described with reference to the accompanying drawings. Configurations, arrangements, shapes and alike shown in the drawings and relevant descriptions to the drawings are intended to make principles of the video technologies easily understood. Therefore, the principles of the video technologies are not limited to the following detailed description.

### (Eyewear Device)

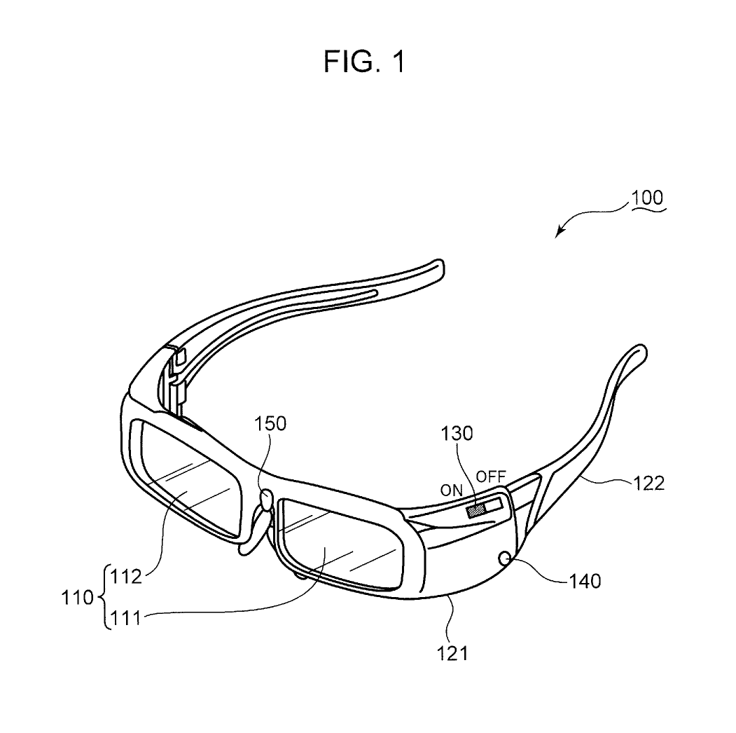

FIG. 1 is a schematic perspective view of the eyewear device 100. The eyewear device 100 is described with reference to FIG. 1.

The eyewear device 100 includes a shutter portion 110 configured to adjust a light amount which is transmitted to the left and right eyes of an observer. The shutter portion 110 includes a left shutter 111 situated in front of the left eye of the observer and a right shutter 112 situated in front of the right eye of the observer.

While a left frame image, which is observed by the left eye, is displayed by a display device (to be described later), the left shutter 111 opens whereas the right shutter 112 closes. Consequently, the video light amount reaching the left eye increases whereas the video light amount reaching the right eye decreases. Therefore, the observer observes the left frame image with the left eye.

While a right frame image, which is observed by the right eye, is displayed by the display device, the left shutter 111 closes whereas the right shutter 112 opens. Consequently, the video light amount reaching the left eye decreases whereas the video light amount reaching the right eye increases. Therefore, the observer observes the right frame image with the right eye.

For example, if the display device alternately displays left and right frame images and if the left and right shutters 111, 112 open and close in synchronization with the left and right frame images as described above, the observer combines the left and right frame images in the brain. Since there is a positional difference between an object rendered in the left frame image and an object rendered in the right frame image, the observer may perceive the object coming out from a display surface on which a video is displayed or receding into the display surface by the positional difference amount (i.e., the observer may stereoscopically perceive the video displayed by the display device). In the present implementation, the opening and closing operation of the left and right shutters 111, 112 in synchronization with display of the left and right frame images assists in observing a stereoscopic video. Therefore, the opening and closing operation of the left and right shutters 111, 112 is exemplified as the assistance operation. The shutter portion 110 uses the left and right shutters 111, 112 to adjust a light amount transmitted to the left and right eyes. Therefore, the shutter portion 110 is exemplified as the light amount adjuster.

The eyewear device 100 includes a frame portion 121, which supports the shutter portion 110, and arm portions 122, which extend from the frame portion 121 toward the ears of the observer. Therefore, the observer may wear the eyewear device 100 like ordinary glasses for visual correction. Thus, the left shutter 111 is situated in front of the left eye and the right shutter 112 is situated in front of the right eye.

The eyewear device 100 further includes a switching device 130 configured to control power supply to the shutter portion 110. If the switching device 130 is set to “on-position” by the observer, the power supply to various elements (to be described later) in the eyewear device 100 is started. If the switching device 130 is set to “off-position” by the observer, the power supply to the various elements in the eyewear device 100 is stopped. Therefore, the observer may use the switching device 130 to prevent unnecessary power consumption.

The eyewear device 100 further includes a plug port 140 for charging. The observer may insert a plug of a power cable (not shown), which is connected to a power source (not shown), into the plug port 140 to charge the eyewear device 100. The eyewear device 100 may be charged without a power cable. For example, the eyewear device 100 may be wirelessly charged.

The eyewear device 100 further includes a communication device 150 configured to communicate with the display device. For example, the communication device 150 is used to transmit a notification signal for notifying a condition of the eyewear device 100. In response to the notification signal, the display device generates and displays a condition image which represents the condition of the eyewear device 100. Consequently, the observer may visually understand the condition of the eyewear device 100. In the present implementation, the communication device 150 is exemplified as the transmitter.

In addition, the communication device 150 is used to receive synchronization control signals from the display device. During an appropriate reception of the synchronization control signals, the left shutter 111 opens in synchronization with display of the left frame image and closes in synchronization with display of the right frame image. The right shutter 112 opens in synchronization with the display of the right frame image and closes in synchronization with the display of the left frame image.

Optionally, the communication device 150 may be used for a pairing operation for identifying a target display device. The aforementioned various communication operations are described later.

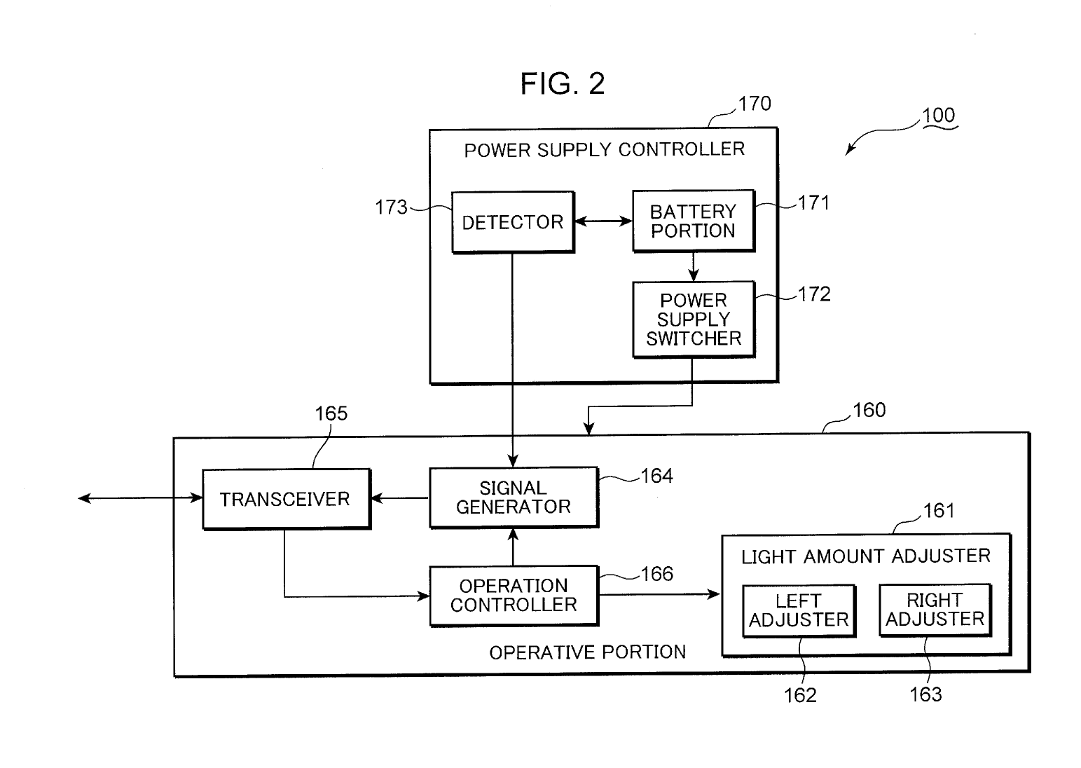

FIG. 2 is a schematic block diagram showing a functional configuration of the eyewear device 100. The eyewear device 100 is further described with reference to FIGS. 1 and 2.

The eyewear device 100 includes an operative portion 160, which carries out the aforementioned assistance operation and communication with the display device, and a power supply controller 170, which controls power supply to the operative portion 160.

The power supply controller 170 includes a battery portion 171, which stores power to be used for the assistance operation and communication with the display device. The battery portion 171 may include the aforementioned plug port 140 with reference to FIG. 1 and a capacitor (not shown) capable of storing external power.

The power supply controller 170 further includes a power supply switcher 172 configured to switch a power supply mode between a power supply operation for supplying power to the operative portion 160 and a stop operation for stopping the power supply operation. The power supply switcher 172 may include the aforementioned switching device 130 with reference to FIG. 1 and a switching circuit (not shown) which switches interconnections in response to operation on the switching device 130. If the observer sets the switching device 130 to the on-position, the power supply switcher 172 executes the power supply operation. If the observer sets the switching device 130 to the off-position, the power supply switcher 172 executes the stop operation. Therefore, the observer may operate the switching device 130 to appropriately switch the power supply mode of the power supply switcher 172. Consequently, unnecessary power supply to the operative portion 160 may be prevented.

The power supply controller 170 further includes a detector 173 configured to detect a power amount and/or a change of the power amount stored in the battery portion 171. The detector 173 outputs data signals which indicate the power amount and/or the change of the power amount stored in the battery portion 171.

The operative portion 160 includes a light amount adjuster 161 configured to perform the assistance operation which assists in observing a video so that the video is stereoscopically perceived. The light amount adjuster 161 consumes the power stored in the battery portion 171 to execute the assistance operation. In addition to the shutter portion 110 described with reference to FIG. 1, the light amount adjuster 161 may include drive circuits for driving the left and right shutters 111, 112.

The light amount adjuster 161 includes a left adjuster 162, which adjusts a video light amount transmitted to the left eye, and a right adjuster 163, which adjusts a video light amount transmitted to the right eye. The left adjuster 162 corresponds to the left shutter 111 described with reference to FIG. 1. Therefore, opening the left shutter 111 means that the left adjuster 162 increases the light amount transmitted to the left eye. Closing the left shutter 111 means that the left adjuster 162 decreases the light amount transmitted to the left eye. The right adjuster 163 corresponds to the right shutter 112 described with reference to FIG. 1. Therefore, opening the right shutter 112 means that the right adjuster 163 increases the light amount transmitted to the right eye. Closing the right shutter 112 means that the right adjuster 163 decreases the light amount transmitted to the right eye.

The operative portion 160 further includes a signal generator 164 configured to generate various signals, which are transmitted to the display device. When the power supply switcher 172 starts the power supply operation, the signal generator 164 generates retrieval signals to identify a communicable or target display device.

The signal generator 164 may receive data signals output from the detector 173 while the power supply switcher 172 carries out the power supply operation. The signal generator 164 may determine a condition of the battery portion 171 in response to the data signals. For example, if the data signals indicate an increase in the power amount inside the battery portion 171, the signal generator 164 may determine that the battery portion 171 is being charged. Otherwise, the signal generator 164 may determine a power amount stored in the battery portion 171 in response to the data signals. The signal generator 164 generates and outputs notification signals containing charge information, which indicates whether or not the battery portion 171 is being charged, and remaining level information, which indicates a power amount stored in the battery portion 171, in response to the data signals.

The operative portion 160 further includes a transceiver 165 configured to perform various types of communication between the eyewear device 100 and the display device. The transceiver 165 transmits the retrieval signals generated by the signal generator 164 at the beginning of the power supply operation by the power supply switcher 172. For example, the retrieval signal may include information about a communication address of the eyewear device 100. If the retrieval signal is received by the display device, the display device then transmits response signals toward the communication address contained in the retrieval signal. For example, the response signal may include information about a communication address of the display device. As a result of the transmission and reception of the retrieval and response signals, the eyewear device 100 and the display device may recognize each other. In the present implementation, the transceiver 165 may include a memory configured to store the communication address of the display device in addition to the aforementioned communication device 150 with reference to FIG. 1.

Subsequently, the transceiver 165 transmits the notification signals generated by the signal generator 164 to the communication address of the recognized display device. Consequently, the condition of the battery portion 171 is notified to the display device. As described above, since the notification signal contains the charge information, the display device may determine whether or not the battery portion 171 is being charged. In addition, since the notification signal contains the remaining level information, the display device may identify a power amount stored in the battery portion 171. In the present implementation, the transceiver 165 is exemplified as the transmitter.

The transceiver 165 may receive synchronization control signals transmitted from the display device. For example, the transceiver 165 may perform filtering process to remove noise from the synchronization control signals.

The operative portion 160 further includes an operation controller 166 configured to control the light amount adjuster 161. The transceiver 165 outputs the synchronization control signals to the operation controller 166. In response to the synchronization control signals, the operation controller 166 controls timings of light amount adjustment operations by means of the left and right adjusters 162, 163. Consequently, while a left frame image is displayed on the display device, the left adjuster 162 increases a light amount transmitted to the left eye whereas the right adjuster 163 decreases a light amount transmitted to the right eye. While a right frame image is displayed on the display device, the left adjuster 162 decreases a light amount transmitted to the left eye whereas the right adjuster 163 increases a light amount transmitted to the right eye.

The operation controller 166 controls the signal generator 164. Unless the response signal is received by the transceiver 165 for a predetermined period of time after the transmission of the aforementioned retrieval signal, the transceiver 165 may notify non-reception of the response signals to the operation controller 166. In this case, the signal generator 164 generates the retrieval signal under control of the operation controller 166 once again. Therefore, the eyewear device 100 may repeatedly transmit the retrieval signals until there is a response from the display device.

### (Display Device)

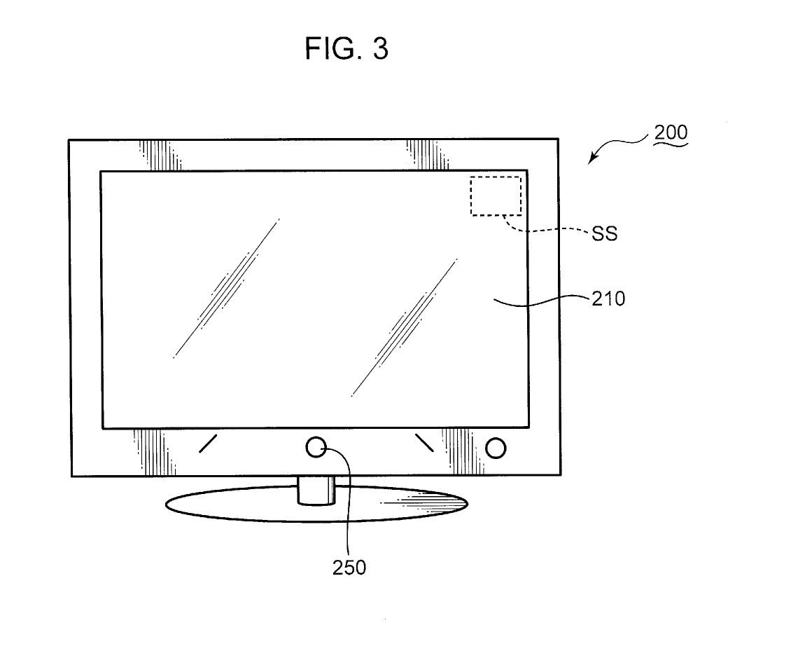

FIG. 3 is a schematic view of the display device 200. The display device 200 is described with reference to FIGS. 1 and 3.

The display device 200 includes a display panel 210, which displays a video, and a communication device 250, which communicates various signals with the eyewear device 100.

The display panel 210 alternately displays left and right frame images. Since the eyewear device 100 performs the assistance operation in synchronization with the display of the left and right frame images, the observer may stereoscopically perceive a video displayed on the display panel 210.

The communication device 250 receives the retrieval signal transmitted by the eyewear device 100. Subsequently, the communication device 250 transmits the response signal to the eyewear device 100. As a result of the transmission and reception of the retrieval and response signals, the eyewear device 100 and the display device 200 may recognize each other.

The communication device 250 receives the notification signals transmitted by the eyewear device 100. Once the notification signal is received by the communication device 250, the display panel 210 displays a condition image which represents the condition of the eyewear device 100. In FIG. 3, a region SS, in which the condition image is displayed, is depicted by a dotted line in the display panel 210. The display panel 210 displays a video by overlaying the condition image with the left or right frame image. Therefore, the observer may confirm a condition of the eyewear device 100 while observing a stereoscopic video. In the present implementation, the communication device 250 is exemplified as the receiver. The display panel 210 is exemplified as the display portion.

The communication device 250 transmits the synchronization control signals to the eyewear device 100. The shutter portion 110 of the eyewear device 100 receives the synchronization control signals to execute the assistance operation in synchronization with display of the left and right frame images displayed on the display panel 210.

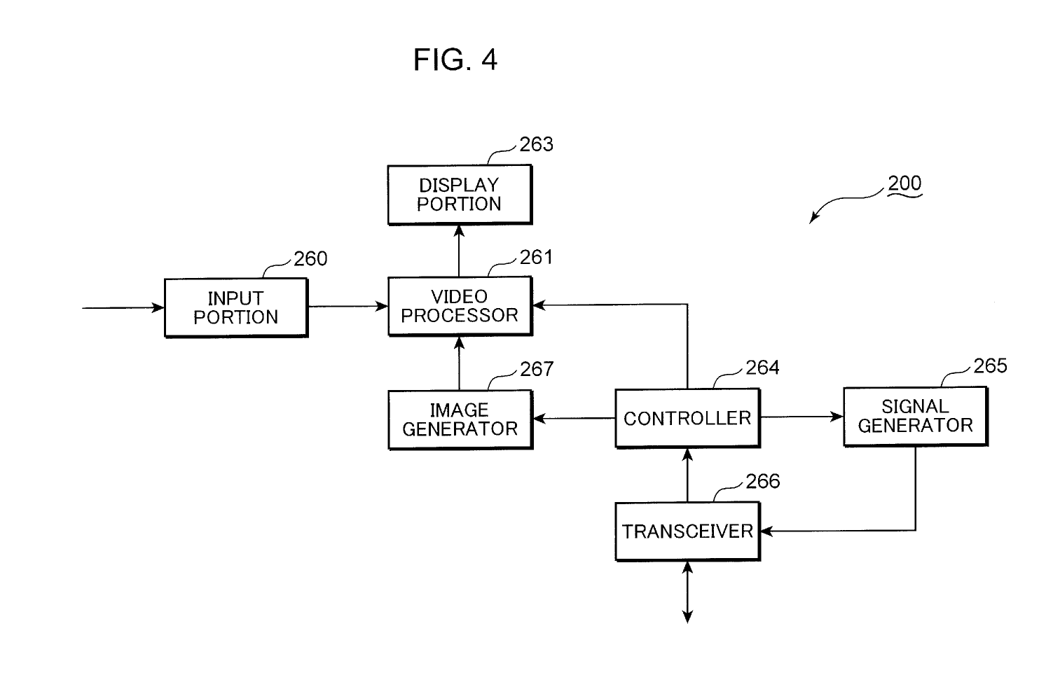

FIG. 4 is a schematic block diagram representing a functional configuration of the display device 200. The display device 200 is further described with reference to FIGS. 2 to 4.

The display device 200 includes an input portion 260 to which video signals are input. The input portion 260 may include an input port, to which coded video signals are input, and a decoding circuit, which decodes the input video signals. The input portion 260 may output decoded video signals to a video processor 261.

The display device 200 further includes the video processor 261 configured to process video signals to create image data. The input portion 260 outputs the video signals to the video processor 261. The video processor 261 uses the video signals to generate data about left and right frame images.

The display device 200 further includes a display portion 263 configured to alternately display the left and right frame images. The video processor 261 alternately outputs data corresponding to the left and right frame images to the display portion 263. Consequently, the display portion 263 may alternately display the left and right frame images. In the present implementation, the display portion 263 corresponds to the aforementioned display panel 210 with reference to FIG. 3.

The display device 200 further includes a controller 264 configured to control the video processor 261. The video processor 261 generates and outputs data about the left and right frame images under control of the controller 264.

The display device 200 further includes a signal generator 265 configured to generate synchronization control signals in synchronization with output of data about the left and right frame images from the video processor 261. Since the signal generator 265 also generates the synchronization control signals under control of the controller 264, the synchronization control signals are appropriately generated in synchronization with the data output about the left and right frame images.

The display device 200 further includes a transceiver 266 configured to transmit the synchronization control signals to the eyewear device 100. As described above, since the signal generator 265 generates the synchronization control signals in synchronization with the data output about the left and right frame images from the video processor 261, the transceiver 266 may output the synchronization control signals to the eyewear device 100 in synchronization with display of the left and right frame images on the display portion 263. In the present implementation, the transceiver 266 corresponds to the aforementioned communication device 250 with reference to FIG. 3.

The transceiver 266 may receive the retrieval signals transmitted by the eyewear device 100. The transceiver 266 may include a memory for storing a communication address contained in the retrieval signals in addition to the communication device 250. The transceiver 266 may store the communication address of the eyewear device 100 in response to the reception of the retrieval signals.

The transceiver 266 receives the retrieval signal and then notifies the reception of the retrieval signal to the controller 264. The controller 264 notified of the reception of the retrieval signal causes the signal generator 265 to generate the response signals. The signal generator 265 generates the response signals so as to contain information about the communication address of the display device 200. The generated response signal is then output to the transceiver 266. The transceiver 266 outputs the response signal toward the stored communication address of the eyewear device 100. Consequently, the display device 200 and the eyewear device 100 may recognize each other.

The transceiver 266 may receive the notification signals transmitted by the eyewear device 100. The transceiver 266 outputs the notification signal to the controller 264. The controller 264 interprets contents of the notification signal. As described above, the notification signal transmitted from the eyewear device 100 contains the charge information. Therefore, the controller 264 may determine whether or not the battery portion 171 is being charged. In addition, the notification signal contains the remaining level information. Therefore, the controller 264 may determine a power amount charged in the battery portion 171. In the present implementation, the transceiver 266 is exemplified as the receiver.

The display device 200 further includes an image generator 267 configured to generate a condition image in response to an interpretation result of the notification signal by the controller 264 (i.e., in response to the notification signal received by the transceiver 266). If the controller 264 determines that the battery portion 171 is not being charged (i.e., if the notification signal contains information indicating that the battery portion 171 is not being charged), the image generator 267 generates a power amount image, which represents a power amount stored in the eyewear device 100 as the condition image, under control of the controller 264. If the controller 264 determines that the battery portion 171 is being charged (i.e., if the notification signal contains information indicating that the battery portion 171 is being charged), the image generator 267 generates a charge image, which represents that the eyewear device 100 is being charged, under control of the controller 264.

The image generator 267 outputs data about the generated condition image to the video processor 261. The video processor 261 incorporates the condition image into left and/or right frame images based on video signals. The video processor 261 then outputs the data about the left and/or right frame images, into which the condition image is incorporated, to the display portion 263. As described above with reference to FIG. 3, the condition image is displayed in the region SS of the display panel 210, which is exemplified as the display portion 263. Consequently, the observer may confirm a condition of the eyewear device 100 while observing a video based on video signals.

Information about whether or not the eyewear device 100 is charged is useful for the observer who charges the eyewear device 100. Therefore, the display of the charge image in the region SS while the eyewear device 100 is being charged is useful for the observer.

Unless the eyewear device 100 is charged, a shortage of a power storage amount in the eyewear device 100 interferes with observation of a video. Therefore, information about the power storage amount in the eyewear device 100 is useful for the observer. Consequently, display of the power amount in the region SS while the eyewear device 100 is not being charged is useful for the observer.

### (Communication Operation of Video System)

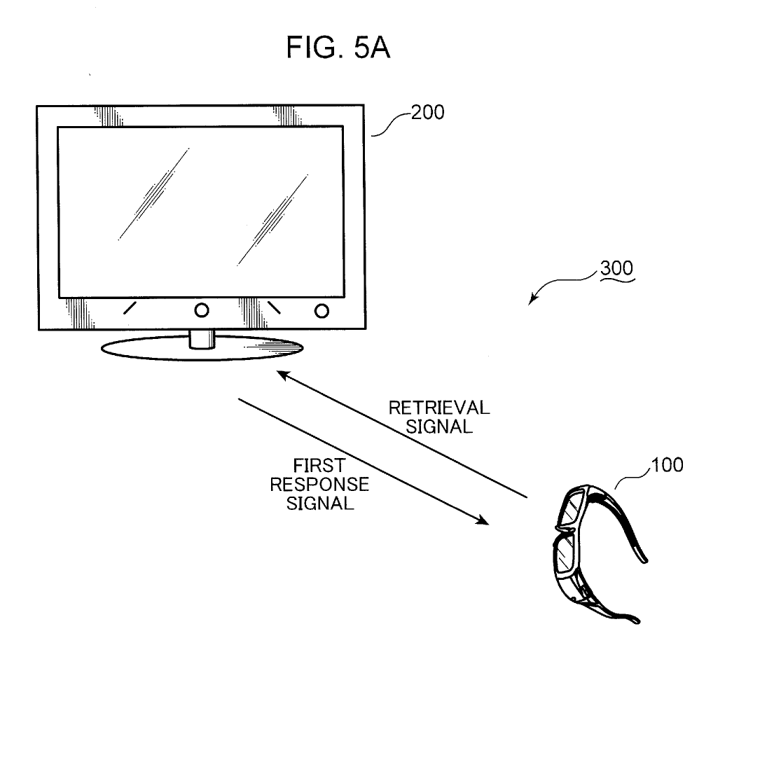

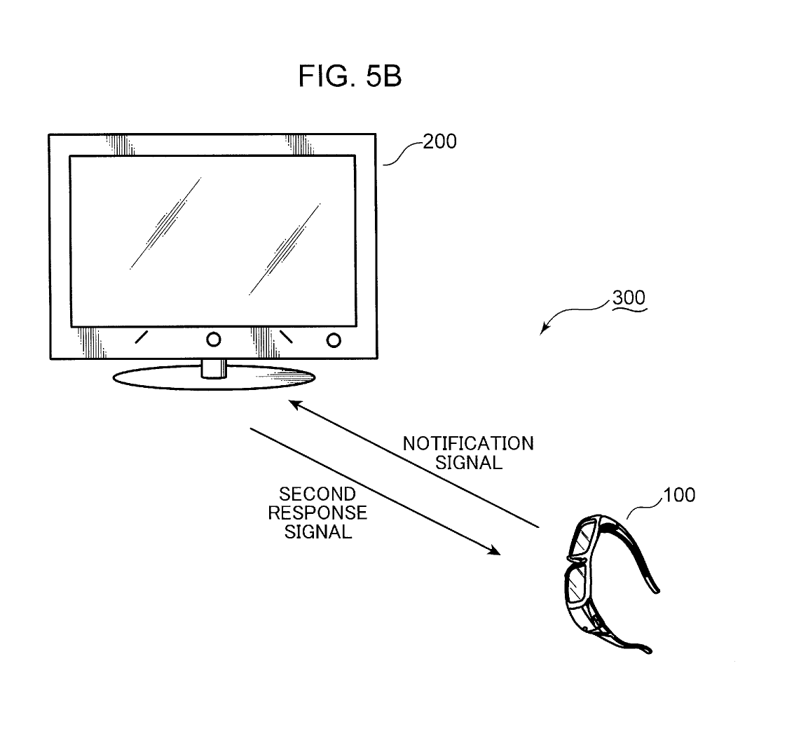

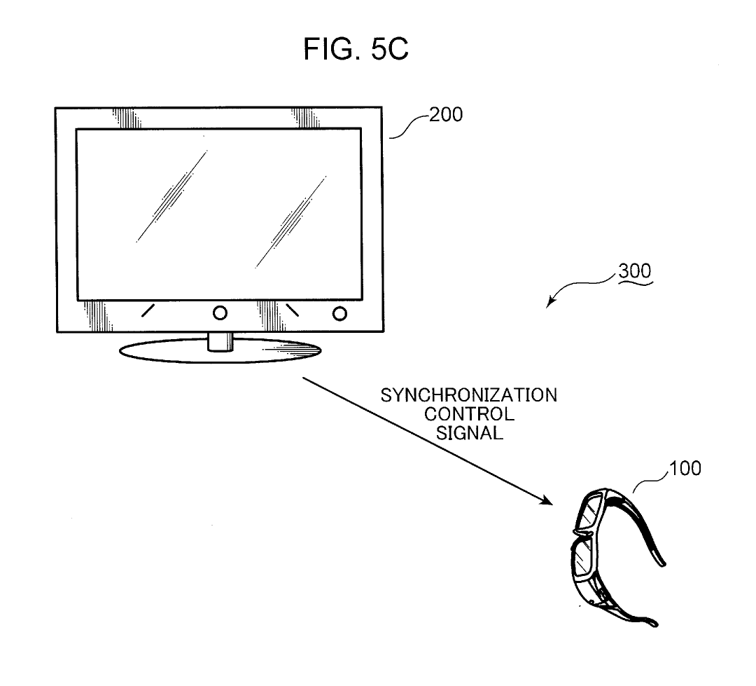

FIG. 5A is a schematic view of the video system 300. The communication operation in the video system 300 is described with reference to FIGS. 2, 4 and 5A.

The video system 300 includes the eyewear device 100 and the display device 200. As described with reference to FIG. 2, when the power supply controller 170 of the eyewear device 100 starts the power supply operation to the operative portion 160, the retrieval signal is transmitted from the eyewear device 100. As described above, the retrieval signal preferably contains the information about the communication address of the eyewear device 100. If the display device 200 exists in a transmission range of the retrieval signal, the display device 200 transmits a response signal (hereinafter, a response signal in correspondence with a retrieval signal is referred to as “first response signal”) toward the communication address contained in the retrieval signal. The first response signal contains information about the communication address of the display device 200. If the eyewear device 100 receives the first response signal, the eyewear device 100 may acquire the information about the communication address of the display device 200.

Unless the eyewear device 100 receives the first response signal within a predetermined period of time from the transmission of the retrieval signal, the transceiver 165 of the eyewear device 100 notifies non-reception of the first response signal to the operation controller 166. Consequently, the operation controller 166 may cause the signal generator 164 to generate a retrieval signal once again. Therefore, the eyewear device 100 may repeatedly transmit the retrieval signals until the first response signal is received.

FIG. 5B is a schematic view of the video system 300. The communication operation in the video system 300 is described with reference to FIGS. 2, 4 to 5B.

Once the transceiver 165 of the eyewear device 100 receives the first response signal, the transceiver 165 notifies the reception of the first response signal to the operation controller 166. Consequently, the operation controller 166 causes the signal generator 164 to generate a notification signal.

As described with reference to FIG. 2, the signal generator 164 receives the data signals from the detector 173. The signal generator 164 determines a condition of the battery portion 171 in response to the data signals. For example, if the data signal indicates an increase in the power amount inside the battery portion 171, the signal generator 164 determines that the battery portion 171 is being charged. Otherwise, the signal generator 164 determines a power amount stored in the battery portion 171 in response to the data signals. On the basis of the data signal, the signal generator 164 generates and outputs a notification signal containing the charge information, which indicates whether or not the battery portion 171 is being charged, and the remaining level information, which indicates a power amount stored in the battery portion 171. The transceiver 165 outputs the generated notification signal toward the communication address of the display device 200.

As described with reference to FIG. 4, once the display device 200 receives the notification signal, the image generator 267 generates a condition image. Consequently, the display portion 263 may display a video, into which the condition image is incorporated. Therefore, the observer may obtain information about the power amount stored in the eyewear device 100.

Upon receiving the notification signal via the transceiver 266, the controller 264 of the display device 200 causes the signal generator 265 to generate a second response signal. The second response signal is transmitted from the transceiver 266 to the communication address of the eyewear device 100.

Unless the eyewear device 100 receives the second response signal within a predetermined period of time from the transmission of the notification signal, the transceiver 165 of the eyewear device 100 notifies non-reception of the second response signal to the operation controller 166. Consequently, the operation controller 166 may cause the signal generator 164 to generate a notification signal once again. Therefore, the eyewear device 100 may repeatedly transmit the notification signals until the second response signal is received.

FIG. 5C is a schematic view of the video system 300. The communication operation in the video system 300 is described with reference to FIGS. 2, 5B and 5C.

After the transmission of the second response signal, the display device 200 repeatedly transmits synchronization control signals to the eyewear device 100. As described above with reference to FIG. 2, the light amount adjuster 161 of the eyewear device 100 performs the assistance operation in response to the synchronization control signals to adjust a light amount transmitted to the left and right eyes.

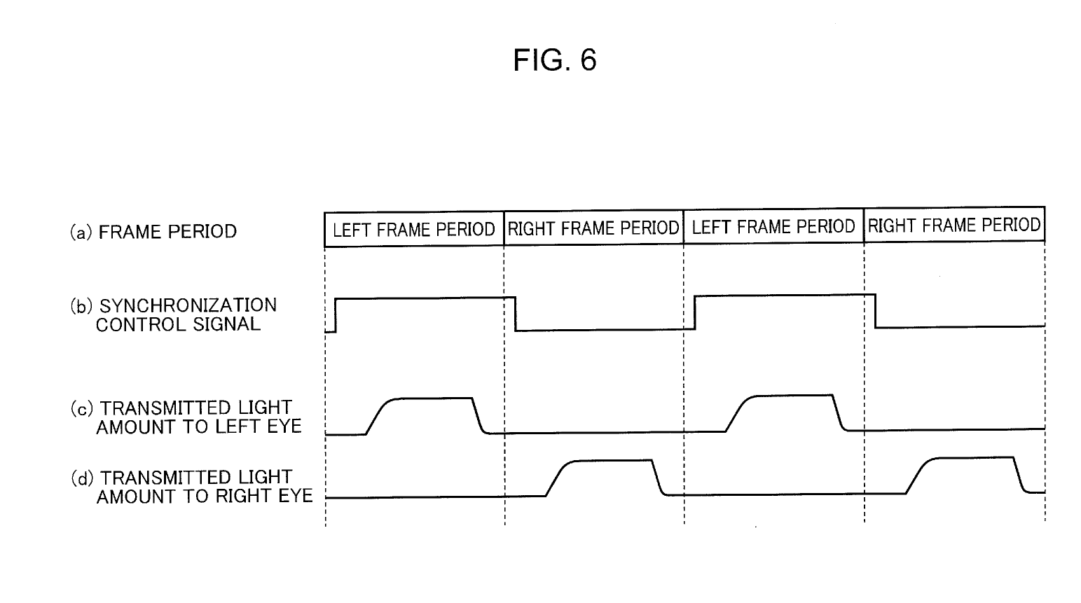

FIG. 6 is a schematic timing chart showing an operation of the light amount adjuster 161 in response to the synchronization control signals. The operation of the light amount adjuster 161 in response to the synchronization control signals is described with reference to FIGS. 2, 5C and 6.

Section (a) in FIG. 6 shows a left frame period allocated as a display period of a left frame image and a right frame period allocated as a display period of a right frame image. The left and right frame periods are alternately allocated.

Section (b) in FIG. 6 shows a synchronization control signal, which is transmitted from the display device 200. The synchronization control signal increases a signal level in synchronization with a start of the left frame period to operate the left adjuster 162. The synchronization control signal decreases the signal level in synchronization with a start of the right frame period to operate the right adjuster 163.

Section (c) in FIG. 6 shows a fluctuation in a transmitted light amount to the left eye. The fluctuation in the transmitted light amount to the left eye corresponds to a light amount adjusting operation by the left adjuster 162. As described above, the left adjuster 162 operates in response to an increase of the signal level in synchronization with the start of the left frame period. Consequently, the light amount transmitted to the left eye increases and decreases in the left frame period. Therefore, the observer observes a video with the left eye in the left frame period. On the other hand, since an increase of the signal level for operating the left adjuster 162 does not occur in the right frame period, the transmitted light amount to the left eye remains at a low level. Therefore, the observer does not observe a video with the left eye in the right frame period.

Section (d) in FIG. 6 represents a fluctuation in a transmitted light amount to the right eye. The fluctuation in the transmitted light amount to the right eye corresponds to a light amount adjusting operation by the right adjuster 163. As described above, the right adjuster 163 operates in response to a decrease of the signal level in synchronization with the start of the right frame period. Consequently, the light amount transmitted to the right eye increases and decreases within the right frame period. Therefore, the observer observes a video with the right eye in the right frame period. On the other hand, since a decrease of the signal level for operating the right adjuster 163 does not occur in the left frame period, the transmitted light amount to the right eye remains at a low level. Therefore, the observer does not observe a video with the right eye in the left frame period.

Due to the aforementioned operation of the light amount adjuster 161, the observer observes the left frame image by the left eye and the right frame image by the right eye. Therefore, the observer may stereoscopically perceive a video displayed on the display device 200.

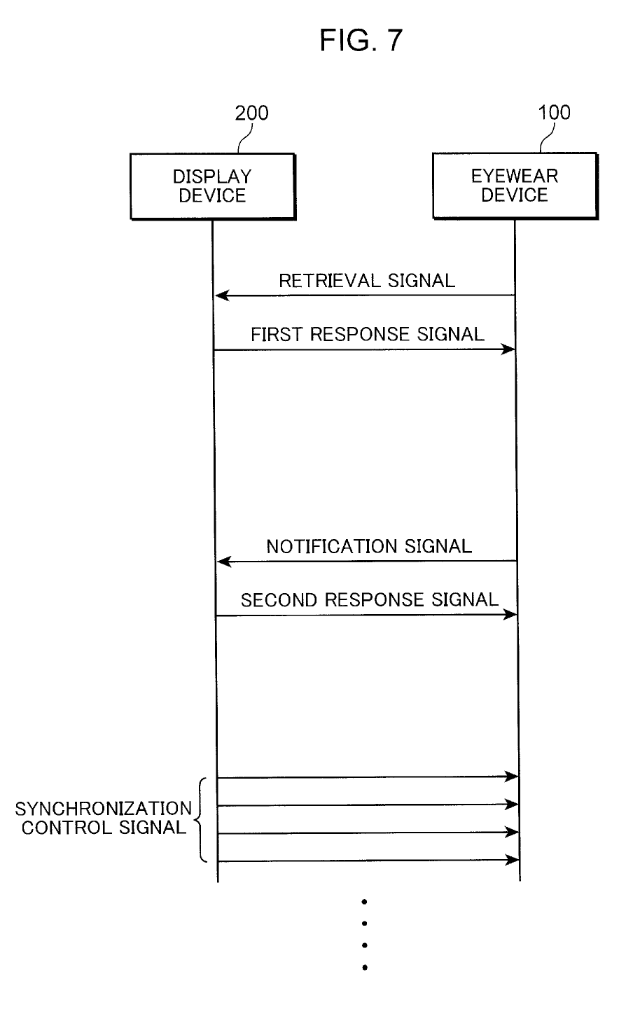

FIG. 7 is a chart schematically showing communication between the eyewear device 100 and the display device 200. The communication between the eyewear device 100 and the display device 200 is described with reference to FIGS. 2 and 7.

As described with reference to FIG. 2, once the power supply controller 170 starts the power supply operation, the retrieval signal is transmitted from the eyewear device 100 to the display device 200. The display device 200 transmits the first response signal to the eyewear device 100 in response to the retrieval signal. Consequently, the eyewear device 100 and the display device 200 may acquire information about each other.

The eyewear device 100 then transmits the notification signal to the display device 200. Consequently, the display device 200 displays a condition image. In addition, the display device 200 transmits the second response signal to the eyewear device 100.

After the transmission of the second response signal, the display device 200 repeatedly transmits synchronization control signals to the eyewear device 100. Consequently, the light amount adjuster 161 may perform the assistance operation in response to the synchronization control signals.

### (Notification Signal)

With respect to the communication between the eyewear device 100 and the display device 200 described with reference to FIG. 7, information is stored in a packet-structure payload section according to a communication system such as Bluetooth (registered trademark), ZigBee and WiFi. Unless the communicated information is contained into a single packet, the information is divided into several packets and communicated between the eyewear device 100 and the display device 200.

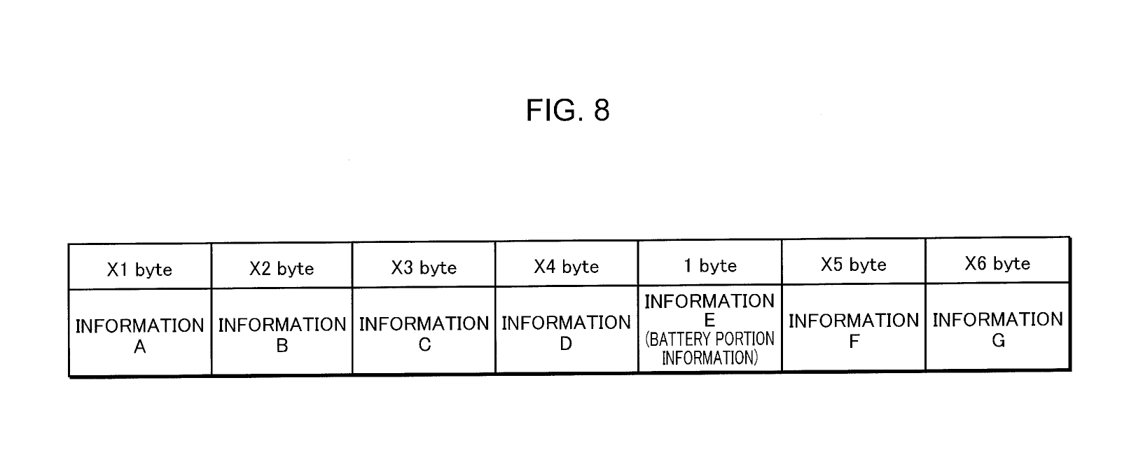

FIG. 8 is a schematic view of a structure of a packet-structured payload section used for the notification signal. The notification signal is described with reference to FIGS. 2, 7 and 8.

The payload section is segmented into data blocks of 1 to several bytes for expressing various types of information (Information A to G is shown in FIG. 8), which are transmitted to the display device 200. In the present implementation, “Information E” represents information about the battery portion 171 (i.e., the charge information and the remaining level information). For example, a data block with a length of “1 byte” may be allocated to “Information E”.

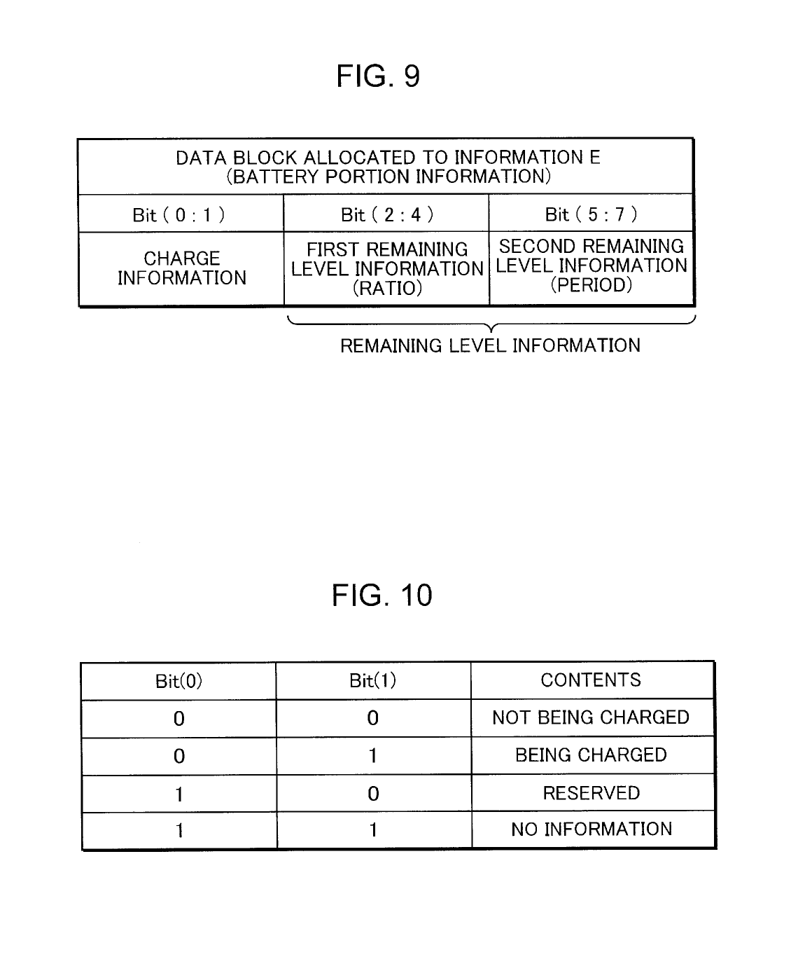

FIG. 9 is a schematic view of a data structure in the data block allocated to Information E. The notification signal is further described with reference to FIGS. 2 and 9.

For example, the data block allocated to information E is divided into “8 bits” (Bit (0) to Bit (7)). The aforementioned charge information is expressed by means of “Bit(0)” and “Bit(1)”. The aforementioned remaining level information is expressed by means of “Bit(2)” to “Bit(7)”.

The remaining level information includes first remaining level information, which indicates a ratio of a present power storage amount to the maximum power storage amount that the battery portion 171 is capable of storing, and second remaining level information, which indicates a period of time for the light amount adjuster 161 to appropriately perform the assistance operation under the present power storage amount. The first remaining level information is expressed by means of “Bit(2)” to “Bit(4)”. The second remaining level information is expressed by means of “Bit(5)” to “Bit(7)”. In the present implementation, the first remaining level information and the second remaining level information are transmitted from the eyewear device 100. Alternatively, the eyewear device may transmit one of the first and second remaining level information.

FIG. 10 is an exemplary table showing an expression pattern of the charge information. The charge information is described with reference to FIGS. 2, 4 and 10.

As described above with reference to FIG. 2, the signal generator 164 determines contents of the charge information in response to the data signal from the detector 173. If the data signal indicates that the battery portion 171 is not being charged, the signal generator 164 assigns a value of “0” to “Bit(0)” and “Bit(1)”, respectively. If the data signal indicates that the battery portion 171 is being charged, the signal generator 164 assigns a value of “0” to “Bit(0)” and a value of “1” to “Bit(1)”. The combination of values “1” and “0” for “Bit(0)” and “Bit(1)” is preliminarily reserved in order to represent other information than the information indicating whether or not the charging is in progress. The combination of values “1” and “1” for “Bit(0)” and “Bit(1)” may be used unless the eyewear device 100 transmits the charge information to the display device 200 or unless the signal generator 164 can determine whether or not the charging is in progress on the basis of the data signals from the detector 173.

Once the controller 264 of the display device 200 finds the combination of values “0” and “0” for “Bit(0)” and “Bit(1)”, the image generator 267 generates a power amount image as the condition image. If the controller 264 finds the combination of values “0” and “1” for “Bit(0)” and “Bit(1)”, the image generator 267 generates a charge image as the condition image.

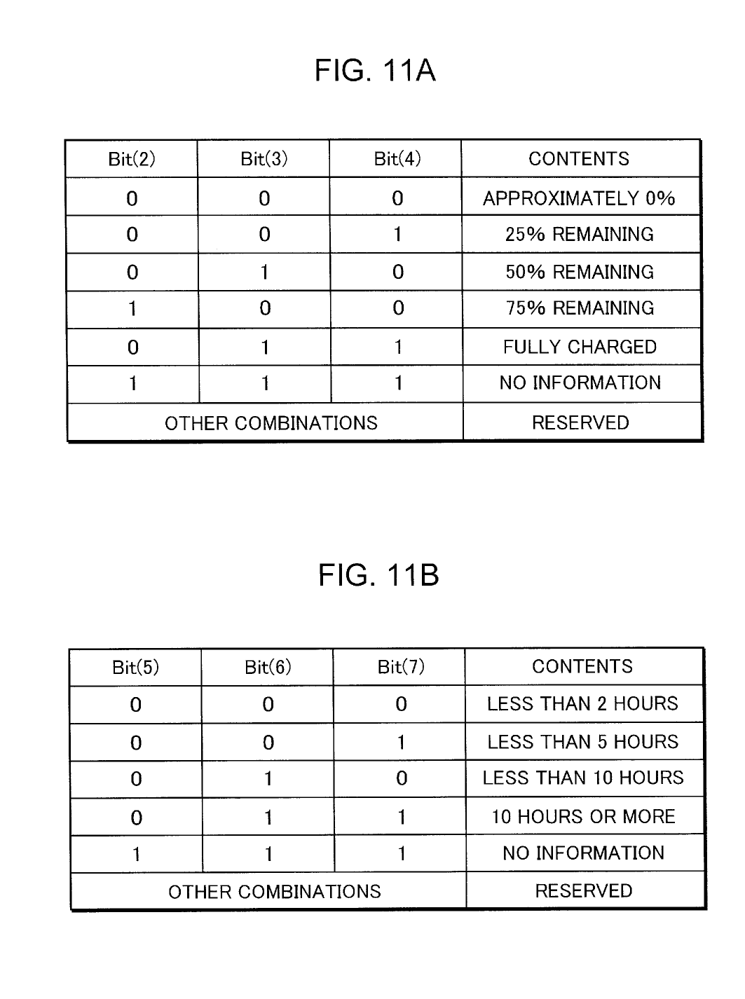

FIG. 11A is an exemplary table showing an expression pattern of the first remaining level information. FIG. 11B is an exemplary table showing an expression pattern of the second remaining level information. The remaining level information is described with reference to FIGS. 2, 4, 10 to 11B.

The signal generator 164 assigns a value of “0” or “1” to “Bit(2)” to “Bit(7)”, respectively, in response to the data signals from the detector 173.

If the data signal from the detector 173 indicates that the power amount stored in the battery portion 171 is approximately “0”, the signal generator 164 assigns a value of “0” to “Bit(2)” to “Bit(4)”, respectively. If the data signal from the detector 173 indicates that the remaining power amount stored in the battery portion 171 is approximately 25%, the signal generator 164 assigns a value of “0” to “Bit(2)” and “Bit(3)” and a value of “1” to “Bit(4)”, respectively. If the data signal from the detector 173 indicates that the remaining power amount stored in the battery portion 171 is approximately 50%, the signal generator 164 assigns a value of “0” to “Bit(2)” and “Bit(4)” and a value of “1” to “Bit(3)”, respectively. If the data signal from the detector 173 indicates that the remaining power amount stored in the battery portion 171 is approximately 75%, the signal generator 164 assigns a value of “0” to “Bit(3)” and “Bit(4)” and a value of “1” to “Bit(2)”, respectively. If the data signal from the detector 173 indicates that the remaining power amount stored in the battery portion 171 is the maximum value, the signal generator 164 assigns a value of “1” to “Bit(3)” and “Bit(4)” and a value of “0” to “Bit(2)”, respectively. If the data signal indicates that there is “no information” about the power storage amount in the battery portion 171, the signal generator 164 assigns a value of “1” to “Bit(2)” to “Bit(4)”, respectively. Other combinations of numerical values assigned to “Bit(2)” to “Bit(4)” are preliminarily reserved in order to represent other remaining level ratios and alike. Therefore, the remaining level ratios of the power amount in the battery portion 171 may be more finely expressed.

If the data signal from the detector 173 indicates that the period of time during which the light amount adjuster 161 can appropriately operate on the basis of the power amount stored in the battery portion 171 is “less than 2 hours”, the signal generator 164 assigns a value of “0” to “Bit(5)” to “Bit(7)”, respectively. If the data signal from the detector 173 indicates that a period of time during which the light amount adjuster 161 can appropriately operate on the basis of the power amount stored in the battery portion 171 is “less than 5 hours”, the signal generator 164 assigns a value of “0” to “Bit(5)” and “Bit(6)” and a value of “1” to “Bit(7)”, respectively. If the data signal from the detector 173 indicates that a period of time during which the light amount adjuster 161 can appropriately operate on the basis of the power amount stored in the battery portion 171 is “less than 10 hours”, the signal generator 164 assigns a value of “0” to “Bit(5)” and “Bit(7)” and a value of “1” to “Bit(6)”, respectively. If the data signal from the detector 173 indicates that a period of time during which the light amount adjuster 161 can appropriately operate on the basis of the power amount stored in the battery portion 171 is “10 hours or more”, the signal generator 164 assigns a value of “1” to “Bit(6)” and “Bit(7)” and a value of “0” to “Bit(5)”, respectively. If the data signal indicates that there is “no information” about the power storage amount in the battery portion 171, the signal generator 164 may assign a value of “1” to “Bit(5)” to “Bit(7)”, respectively. Other combinations of numerical values assigned to “Bit(5)” to “Bit(7)” are preliminarily reserved in order to represent other operating times of the light amount adjuster 161 and alike. Therefore, the operating times of the light amount adjuster 161 may be more finely expressed.

If the controller 264 of the display device 200 finds that numerical values assigned to “Bit(2)” to “Bit(4)” are all “0”, the image generator 267 displays a first power amount image which represents that the power amount remaining in the battery portion 171 is “approximately 0%”. If the controller 264 finds that numerical values assigned to “Bit(2)” and “Bit(3)” are “0” and a numerical value assigned to “Bit(4)” is “1”, the image generator 267 displays a first power amount image which represents that the power amount remaining in the battery portion 171 is “25%”. If the controller 264 finds that numerical values assigned to “Bit(2)” and “Bit(4)” are “0” and a numerical value assigned to “Bit(3)” is “1”, the image generator 267 displays a first power amount image which represents that the power amount remaining in the battery portion 171 is “50%”. If the controller 264 finds that numerical values assigned to “Bit(3)” and “Bit(4)” are “0” and a numerical value assigned to “Bit(2)” is “1”, the image generator 267 displays a first power amount image which represents that the power amount remaining in the battery portion 171 is “75%”. If the controller 264 finds that numerical values assigned to “Bit(3)” and “Bit(4)” are “1” and a numerical value assigned to “Bit(2)” is “0”, the image generator 267 displays a first power amount image which represents that the power amount remaining in the battery portion 171 is the maximum value. If the controller 264 of the display device 200 finds that numerical values assigned to “Bit(2)” to “Bit(4)” are all “1”, the display device 200 may display an image which represents that there is “no information” about power storage amounts.

If the controller 264 of the display device 200 finds that numerical values assigned to “Bit(5)” to “Bit(7)” are all “0”, the image generator 267 displays a second power amount image which represents that a period of time during which the light amount adjuster 161 may continue the assistance operation is “less than 2 hours”. If the controller 264 finds that numerical values assigned to “Bit(5)” and “Bit(6)” are “0” and a numerical value assigned to “Bit(7)” is “1”, the image generator 267 displays a second power amount image which represents that a period of time during which the light amount adjuster 161 may continue the assistance operation is “less than 5 hours”. If the controller 264 finds that numerical values assigned to “Bit(5)” and “Bit(7)” are “0” and a numerical value assigned to “Bit(6)” is “1”, the image generator 267 displays a second power amount image which represents that a period of time during which the light amount adjuster 161 may continue the assistance operation is “less than 10 hours”. If the controller 264 finds that numerical values assigned to “Bit(6)” and “Bit(7)” are “1” and a numerical value assigned to “Bit(5)” is “0”, the image generator 267 displays a second power amount image which represents that a period of time during which the light amount adjuster 161 may continue the assistance operation is “10 hours or more”. If the controller 264 of the display device 200 finds that numerical values assigned to “Bit(5)” to “Bit(7)” are all “1”, the display device 200 may display an image which represents that there is “no information” about power storage amounts.

The transceiver 266 of the display device 200 may receive operation signals from a remote controller (not shown) for operating the display device 200. In this case, the user may selectively display the first and second power amount images.

The transceiver 266 outputs the operation signal, which is sent from the remote controller, to the controller 264. If the operation signal instructs the first power amount image to be displayed, the controller 264 may cause the image generator 267 to generate only the first power amount image. If the operation signal instructs the second power amount image to be displayed, the controller 264 may cause the image generator 267 to generate only the second power amount image. Optionally, the image generator 267 may generate both the first and second power amount images.

### (Video System Control Method)

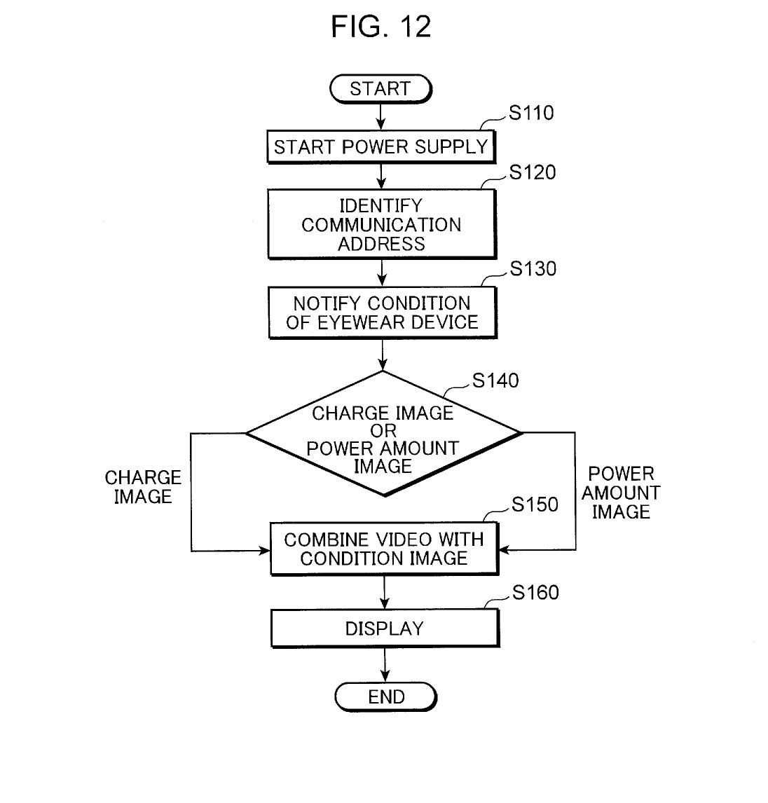

FIG. 12 is a schematic flow chart of a method for controlling the video system 300. The method for controlling the video system 300 is described with reference to FIGS. 2, 4 to 5C and 12.

### (Step S110)

In step S110, power supply from the power supply controller 170 to the operative portion 160 of the eyewear device 100 is started. Subsequently, step S120 is executed.

### (Step S120)

In step S120, a retrieval signal is transmitted from the eyewear device 100 to the display device 200. The display device 200 receives the retrieval signal and transmits a first response signal to the eyewear device 100. Consequently, the eyewear device 100 and the display device 200 may mutually identify their communication addresses. Subsequently, step S130 is executed.

### (Step S130)

In step S130, a notification signal is transmitted from the eyewear device 100 to the display device 200. Consequently, the display device 200 may grasp a condition of the eyewear device 100. The display device 200 receives the notification signal and transmits a second response signal to the eyewear device 100. Subsequently, step S140 is executed.

### (Step S140)

In step S140, the controller 264 of the display device 200 selects one of the charge image and the power amount image (the first and/or second power amount images) to be displayed. If the notification signal indicates that the eyewear device 100 is being charged, the controller 264 selects the charge image to be displayed. If the notification signal indicates that the eyewear device 100 is not being charged, the controller 264 selects the power amount image to be displayed. Subsequently, step S150 is executed.

### (Step S150)

In step S150, the image generator 267 generates the condition image selected by the controller 264. If the controller 264 selects the charge image to be displayed, the image generator 267 generates the charge image. If the controller 264 selects the power amount image to be displayed, the image generator 267 generates the power amount image.

The video processor 261 combines the condition image generated by the image generator 267 to a video based on video signals input via the input portion 260. Data about the composite video are output to the display portion 263. Subsequently, step S160 is executed.

### (Step S160)

In step S160, the display portion 263 displays a video in response to the video data output from the video processor 261. Consequently, useful information about a condition of the eyewear device 100 is transmitted to the observer.

The aforementioned various implementations are merely exemplary. Therefore, the principles of the aforementioned implementations are not limited to the detailed description above or to the contents of the drawings. It will be apparent to those skilled in the art that various modifications, combinations, and omissions can be made within a scope of the principles of the aforementioned implementations.

If the eyewear device is configured to transmit notification signals, the eyewear device may have different configurations. If the display device is configured to appropriately display a condition image in response to a notification signal, the display device may have different configurations.

In the present implementation, the notification signal is transmitted at the beginning of power supply in the eyewear device. Alternatively, the notification signal may be transmitted at other timings. For example, the notification signal may be transmitted at the beginning of charging to the eyewear device. Alternatively, the notification signal may be transmitted when the power amount stored in the eyewear device is changed (e.g., when a power storage amount changes from 50% to 25%).

Communication techniques used in other stereoscopic video systems may be applied to the synchronization control between the eyewear device and the display device. The principles of the stereoscopic video may be suitably utilized in the techniques of the other stereoscopic video systems.

The notification signal may have other data structures as long as information about a battery portion can be transmitted. If a long data length can be allocated to battery portion information, various types of information about the battery portion may be transmitted to the display device.

The aforementioned implementations mainly include the following features.

An eyewear device according to one aspect of the aforementioned implementation includes: a light amount adjuster which adjusts a light amount transmitted to left and right eyes of an observer to perform an assistance operation that assists in observing a video so that the video is stereoscopically perceived; a battery portion which stores power for the light amount adjuster to perform the assistance operation; and a transmitter configured to transmit a notification signal for notifying a condition of the battery portion. The notification signal contains charge information, which indicates whether or not the battery portion is being charged, and remaining level information, which indicates a power amount stored in the battery portion.

According to the aforementioned configuration, the light amount adjuster consumes power stored in the battery portion to perform the assistance operation which assists in observing a video. As a result of the assistance operation, a light amount transmitted to the left and right eyes is appropriately adjusted so that an observer may stereoscopically perceive the video.

The transmitter transmits a notification signal to notify a condition of the battery portion. The notification signal contains charge information, which indicates whether or not the battery portion is being charged, and remaining level information, which indicates a power amount stored in the battery portion. Since it depends on the charge information that is useful for the observer whether the remaining level information is utilized, a condition of the eyewear device may be appropriately notified to the observer.

In the aforementioned configuration, the remaining level information may indicate at least one of first remaining level information, which represents a ratio of the power amount to a maximum power storage amount that the battery portion is capable of storing, and second remaining level information, which represents a period of time for the light amount adjuster to perform the assistance operation in response to the power amount.

According to the aforementioned configuration, the remaining level information may indicate at least one of the first remaining level information, which represents a ratio of the power amount to the maximum power storage amount that the battery portion is capable of storing, and the second remaining level information, which represents a period of time for the light amount adjuster to perform the assistance operation in response to the power amount. If the first remaining level information is used, the observer may intuitively understand a power amount stored in the eyewear device. If the second remaining level information is used, the observer may appropriately understand an operation time of the eyewear device. Therefore, the condition of the eyewear device is appropriately notified to the observer.

A display device according to another aspect of the aforementioned implementation includes: a receiver configured to receive a notification signal for notifying a condition of an eyewear device which performs an assistance operation to assist in observing a video so that the video is stereoscopically perceived; an image generator configured to generate a condition image which represents the condition of the eyewear device in response to the notification signal received by the receiver; and a display portion configured to display the condition image. The notification signal contains charge information, which indicates whether or not the eyewear device is being charged, and remaining level information, which indicates a power amount stored in the eyewear device. The image generator generates a power amount image, which represents the power amount stored in the eyewear device, as the condition image if the charge information indicates that the eyewear device is not being charged.

According to the aforementioned configuration, the receiver receives a notification signal for notifying a condition of the eyewear device which performs an assistance operation to assist in observing a video so that the video is stereoscopically perceived. The image generator generates a condition image, which represents the condition of the eyewear device in response to the notification signal received by the receiver. Since the display portion displays the condition image, the observer may appropriately understand the condition of the eyewear device.

The notification signal contains the charge information, which indicates whether or not the eyewear device is being charged, and the remaining level information, which indicates a power amount stored in the eyewear device. If the charge information indicates that the eyewear device is not being charged, the image generator generates a power amount image, which represents the power amount stored in the eyewear device, as the condition image. Unless the battery portion is being charged, the remaining level information is useful for the observer. Therefore, appropriate information about a condition of the eyewear device is notified to the observer.

In the aforementioned configuration, if the image generator generates the power amount image, the display portion may display at least one of a first power amount image, which represents a ratio of the power amount to a maximum power storage amount that the eyewear device is capable of storing, and a second power amount image, which represents a period of time for the eyewear device to perform the assistance operation in response to the power amount, as the power amount image.

According to the aforementioned configuration, if the image generator generates a power amount image, the display portion may display at least one of a first power amount image, which represents a ratio of the power amount to the maximum power storage amount that the eyewear device is capable of storing, and a second power amount image, which represents a period of time for the eyewear device to perform the assistance operation in response to the power amount, as the power amount image. If the first power amount image is displayed, the observer may intuitively understand the power amount stored in the eyewear device. If the second power amount image is displayed, the observer may appropriately understand an operation time of the eyewear device. Therefore, a condition of the eyewear device is appropriately notified to the observer.

In the aforementioned configuration, if the charge information indicates that the eyewear device is being charged, the image generator may generate a charge image, which represents that the eyewear device is being charged, as the condition image.

According to the aforementioned configuration, since the image generator generates a charge image, which represents that the eyewear device is being charged, as the condition image if the charge information indicates that the eyewear device is being charged, the observer may appropriately understand that the eyewear device is being charged.

A video system according to another aspect of the aforementioned implementation includes: a display device configured to display a video which is stereoscopically perceived by an observer; and an eyewear device configured to perform an assistance operation which assists in observing the video so that the video is stereoscopically perceived. The eyewear device includes: a light amount adjuster which adjusts a light amount transmitted to left and right eyes of the observer to perform the assistance operation; a battery portion which stores power for the light amount adjuster to perform the assistance operation; and a transmitter configured to transmit a notification signal for notifying a condition of the battery portion. The notification signal contains charge information, which indicates whether or not the battery portion is being charged, and remaining level information, which indicates a power amount stored in the battery portion. The display device includes: a receiver configured to receive the notification signal; an image generator configured to generate a condition image, which represents the condition of the battery portion, in response to the notification signal received by the receiver; and a display portion configured to display the condition image. The image generator generates a power amount image, which represents a power amount stored in the battery portion, as the condition image if the charge information indicates that the battery portion is not being charged.

According to the aforementioned configuration, the display device displays a video which is stereoscopically perceived by the observer. The eyewear device performs an assistance operation to assist in observing the video so that the video is stereoscopically perceived. Therefore, the observer may appropriately observe a stereoscopic video through the eyewear device.

The light amount adjuster consumes power stored in the battery portion to perform the assistance operation which assists in observing the video. As a result of the assistance operation, a light amount transmitted to the left and right eyes of the observer is appropriately adjusted. Therefore, the observer may stereoscopically perceive the video.

The transmitter of the eyewear device transmits a notification signal for notifying a condition of the battery portion. The receiver of the display device receives the notification signal. The image generator generates a condition image which represents the condition of the eyewear device in response to the notification signal received by the receiver. Since the display portion displays the condition image, the observer may appropriately understand the condition of the eyewear device.

The notification signal contains the charge information, which indicates whether or not the eyewear device is being charged, and the remaining level information, which indicates a power amount stored in the eyewear device. If the charge information indicates that the eyewear device is not being charged, the image generator generates a power amount image, which represents a power amount stored in the eyewear device, as the condition image. Unless the battery portion is being charged, the remaining level information is useful for the observer. Therefore, appropriate information about the condition of the eyewear device is notified to the observer.

A video system control method according to another aspect of the aforementioned implementation includes steps of communicating a notification signal between a display device, which displays a stereoscopic video, and an eyewear device, which performs an assistance operation that assists in observing the video, in order to notify a condition of the eyewear device; and causing the display device to generate and display a condition image which represents the condition of the eyewear device in response to the notification signal. The notification signal contains charge information, which indicates whether or not the eyewear device is being charged, and remaining level information, which indicates a power amount stored in the eyewear device. The display device generates and displays a power amount image which represents a power amount stored in the eyewear device as the condition image if the charge information indicates that the eyewear device is not being charged.

According to the aforementioned configuration, the notification signal for notifying a condition of the eyewear device is communicated between the display device, which displays a stereoscopic video, and the eyewear device, which performs an assistance operation to assist in observing the video. Consequently, the display device generates and displays a condition image, which represents a condition of the eyewear device. The notification signal contains the charge information, which indicates whether or not the eyewear device is being charged, and the remaining level information, which indicates a power amount stored in the eyewear device. If the charge information indicates that the eyewear device is not being charged, the display device generates a power amount image, which represents a power amount stored in the eyewear device, as the condition image. Unless the battery portion is being charged, the remaining level information is useful for the observer. Therefore, appropriate information about the condition of the eyewear device is notified to the observer.

### INDUSTRIAL APPLICABILITY

The principles of the aforementioned implementations may be suitably used in video technologies which allow a video to be observed under assistance of an eyewear device.

1. An eyewear device comprising:
a light amount adjuster which adjusts a light amount transmitted to left and right eyes of an observer to perform an assistance operation that assists in observing a video so that the video is stereoscopically perceived;
a battery portion which stores power for the light amount adjuster to perform the assistance operation; and
a transmitter configured to transmit a notification signal for notifying a condition of the battery portion, wherein
the notification signal contains charge information, which indicates whether or not the battery portion is being charged, and remaining level information, which indicates a power amount stored in the battery portion.

2. The eyewear device according to claim 1, wherein
the remaining level information indicates at least one of first remaining level information, which represents a ratio of the power amount to a maximum power storage amount that the battery portion is capable of storing, and second remaining level information, which represents a period of time for the light amount adjuster to perform the assistance operation in response to the power amount.

3. A display device comprising:
a receiver configured to receive a notification signal for notifying a condition of an eyewear device which performs an assistance operation to assist in observing a video so that the video is stereoscopically perceived;
an image generator configured to generate a condition image which represents the condition of the eyewear device in response to the notification signal received by the receiver; and
a display portion configured to display the condition image, wherein
the notification signal contains charge information, which indicates whether or not the eyewear device is being charged, and remaining level information, which indicates a power amount stored in the eyewear device, and
the image generator generates a power amount image, which represents the power amount stored in the eyewear device, as the condition image if the charge information indicates that the eyewear device is not being charged.

4. The display device according to claim 3, wherein
if the image generator generates the power amount image, the display portion displays at least one of a first power amount image, which represents a ratio of the power amount to a maximum power storage amount that the eyewear device is capable of storing, and a second power amount image, which represents a period of time for the eyewear device to perform the assistance operation in response to the power amount, as the power amount image.

5. The display device according to claim 3, wherein
if the charge information indicates that the eyewear device is being charged, the image generator generates a charge image, which represents that the eyewear device is being charged, as the condition image.

6. A video system comprising:
a display device configured to display a video which is stereoscopically perceived by an observer; and
an eyewear device configured to perform an assistance operation which assists in observing the video so that the video is stereoscopically perceived, wherein
the eyewear device includes:
a light amount adjuster which adjusts a light amount transmitted to left and right eyes of the observer to perform the assistance operation;
a battery portion which stores power for the light amount adjuster to perform the assistance operation; and
a transmitter configured to transmit a notification signal for notifying a condition of the battery portion,
the notification signal contains charge information, which indicates whether or not the battery portion is being charged, and remaining level information, which indicates a power amount stored in the battery portion,
the display device includes:
a receiver configured to receive the notification signal;
an image generator configured to generate a condition image, which represents the condition of the battery portion, in response to the notification signal received by the receiver; and
a display portion configured to display the condition image, and
the image generator generates a power amount image, which represents a power amount stored in the battery portion, as the condition image if the charge information indicates that the battery portion is not being charged.

7. A video system control method comprising:
communicating a notification signal between a display device, which displays a stereoscopic video, and an eyewear device, which performs an assistance operation that assists in observing the video, in order to notify a condition of the eyewear device; and
causing the display device to generate and display a condition image which represents the condition of the eyewear device in response to the notification signal, wherein
the notification signal contains charge information, which indicates whether or not the eyewear device is being charged, and remaining level information, which indicates a power amount stored in the eyewear device, and
the display device generates and displays a power amount image which represents a power amount stored in the eyewear device as the condition image if the charge information indicates that the eyewear device is not being charged.
